(19) United States
(12) Patent Application Publication
(10) Pub. No.: US 2017/0316849 A1
(43) Pub. Date: Nov. 2, 2017

(54) INSULATION WIRE, MANUFACTURING METHOD OF THE SAME, AND MANUFACTURING METHOD OF ELECTRIC MACHINE

(71) Applicant: HITACHI METALS, LTD., Tokyo (JP)

(72) Inventors: Yoshiaki OKABE, Tokyo (JP); Shintaro TAKEDA, Tokyo (JP)

(73) Assignee: HITACHI METALS, LTD., Tokyo (JP)

(21) Appl. No.: 15/459,121

(22) Filed: Mar. 15, 2017

(30) Foreign Application Priority Data
Apr. 27, 2016 (JP) 2016-089671

(51) Int. Cl. H01B 7/02; H01F 41/06; H01F 5/06; H01B 13/06; H01B 13/00; H01B 3/42; H01B 3/30; H02K 15/085

(52) U.S. Cl. CPC H01B 7/0216; H02K 15/085; H01F 41/06; H01F 5/06; H01B 3/301; H01B 13/003; H01B 3/427; H01B 3/308; H01B 13/06

(57) ABSTRACT

An insulation wire includes a conductor, a first insulating layer formed in an outer surface of the conductor, and a second insulating layer formed in an outer surface of the first insulating layer. In the insulation wire, the first insulating layer is a thermoplastic resin layer that is made of polyphenylene sulfide or polyether ether ketone, and the second insulating layer is a thermosetting resin layer.

### BACKGROUND OF THE INVENTION

### 1. Field of the Invention

The present invention relates to an insulation wire, a manufacturing method of the insulation wire, and a manufacturing method of an electric machine.

### 2. Description of the Related Art

Conventionally, there is known a self-fusion insulation wire in which a self-fusion layer is provided in the outermost layer and an inner insulating layer is made of polyphenylene sulfide (see JP H04-073811 A). Such a self-fusion insulation wire is excellent in refrigerant resistance, heat resistance, and moist-heat resistance, and mainly used in a motor for compression.

In addition, there is disclosed an invention relating to a resin additive which can improve an electric performance of an insulator of a power cable (DC power cable) made of an olefinic resin for DC power transmission, and can reduce a chance of contamination with a foreign substance (see JP 2009-114267 A). JP 2009-114267 A discloses that a specific resin additive is mixed to the polyolefinic resin and coated as an insulator of the DC power cable by extrusion during manufacture of the DC power cable.

### SUMMARY OF THE INVENTION

Household or industry electric machines, ships, railway vehicles, and electric vehicles are provided with an electric machine such as a motor which has a coil obtained by wounding the insulation wire for example. A miniaturization and an increasing output power are requested for the electric machine having the coil of the insulation wire. In order to achieve the miniaturization and the increasing output power of the electric machine having the coil, there is a need to more securely prevent a breakdown caused by the partial discharge between the near insulation wires or a surge voltage.

JP H04-073811 A discloses a manufacturing method of the self-fusion layer in the outermost layer of the self-fusion insulation wire, in which the self-fusion layer is manufactured by coating and baking using a cross-linking resin composition. However, there is a need to repeatedly perform the coating and the baking plural times using the cross-linking resin composition in order to form the self-fusion layer having a thickness enough to more securely prevent the breakdown. Therefore, there is a concern that a reduction in productivity and an increase in manufacturing costs may be caused.

On the other hand, the DC power cable disclosed in JP 2009-114267 A is manufactured by providing an inner semiconductor layer in the outer periphery of a conductor of the power cable, coating the polyolefinic resin in the outer periphery to form an insulator layer, and performing a cross-linking process after providing an outer semiconductor layer in the outer periphery. In the extrusion coating, a temperature to heat the material of the insulator layer have to be set lower than a heating temperature in the cross-linking process. Therefore, in a case where a melting temperature of the material of the insulator layer is high, there is a concern that the insulator layer may be not formed by the extrusion coating.

The invention has been made in view of the above problems, and an object thereof is to provide an insulation wire, a manufacturing method of the insulation wire, and a manufacturing method of an electric machine which can securely prevent a breakdown compared to the related art while suppressing a reduction in productivity and an increase in manufacturing costs.

According to the invention to solve the above problems, there is provided an insulation wire including: a conductor; a first insulating layer formed in an outer surface of the conductor; and a second insulating layer formed in an outer surface of the first insulating layer. The first insulating layer is a thermoplastic resin layer that is made of polyphenylene sulfide or polyether ether ketone. The second insulating layer is a thermosetting resin layer that is made of an uncured thermosetting resin.

According to the invention, it is possible to provide an insulation wire, a manufacturing method of the insulation wire, and a manufacturing method of an electric machine which can securely prevent a breakdown compared to the related art while suppressing a reduction in productivity and an increase in manufacturing costs.

### BRIEF DESCRIPTION OF THE DRAWINGS

FIG. 1 is a cross-sectional view of an insulation wire according to an embodiment of the invention;

FIG. 2 is a flowchart of a manufacturing method of the insulation wire according to the embodiment of the invention;

FIG. 3 is a schematic view for describing a first molding process illustrated in FIG. 2;

FIG. 4 is a schematic view for describing a second molding process and a plasma treatment process illustrated in FIG. 2;

FIG. 5 is a plan view illustrating part of a motor which is an electric machine according to the embodiment of the invention; and

FIG. 6 is a perspective view of a test piece to measure a tensile strength (adhesive force) of the insulation wire.

### DESCRIPTION OF THE PREFERRED EMBODIMENTS

Hereinafter, embodiments of an insulation wire and a manufacturing method thereof according to the invention will be described, and an embodiment of a manufacturing method of an electric machine which uses the insulation wire according to the invention will be described.

### [Insulation Wire]

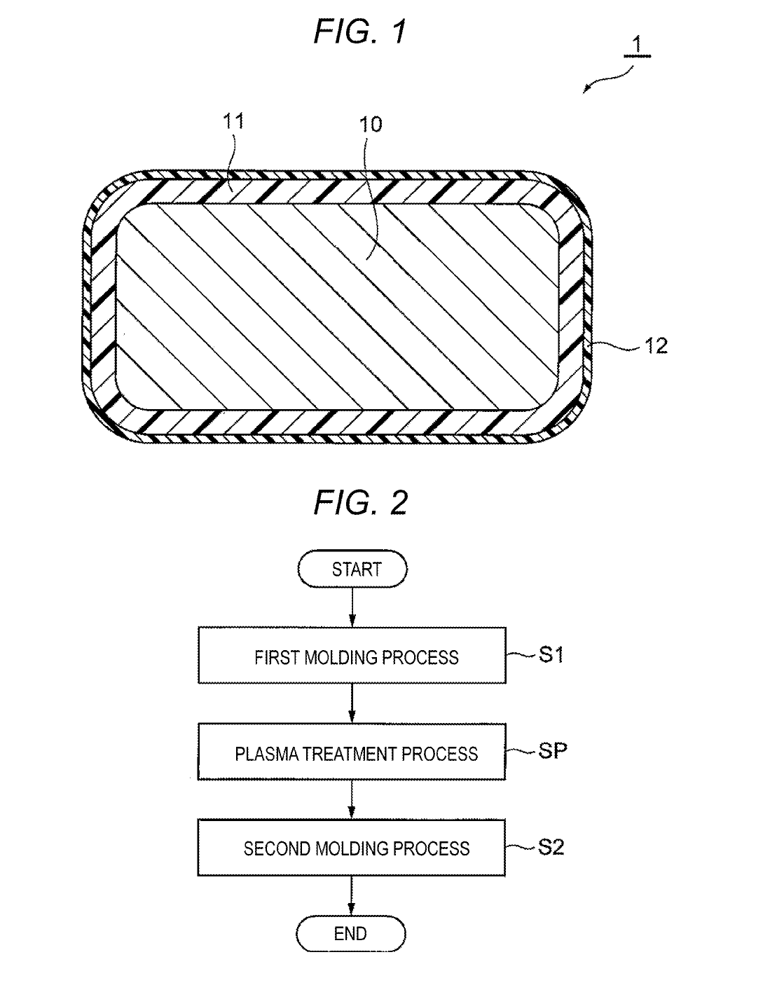

FIG. 1 is a cross-sectional view of an insulation wire 1 according to the embodiment of the invention. The insulation wire 1 of this embodiment is used as a coil winding of an electric machine such as a motor and an inverter provided in, for example, household or industry electric machines, ships, railway vehicles, and electric vehicles.

The insulation wire 1 includes a conductor 10, a first insulating layer 11 which is formed in an outer surface of the conductor 10, and a second insulating layer 12 which is formed in an outer surface of the first insulating layer 11. The insulation wire 1 of this embodiment is configured such that the first insulating layer 11 is a thermoplastic resin layer made of polyphenylene sulfide (PPS) or polyether ether ketone (PEEK), and the second insulating layer 12 is a thermosetting resin layer made of an uncured thermosetting resin. The uncured thermosetting resin means a thermosetting resin in which an epoxy group, a curing agent, and a curing accelerator are kneaded and are coated on the first insulating layer and, in this state, not subjected to a cross-linking (curing) reaction by heating.

The conductor 10 is a conductor of a line shape similar to a core of a typical insulation wire and may be formed in a circular wire in cross section view, a rectangular wire in cross-sectional view, or an octagon wire in cross-sectional view for example. In addition, the conductor 10 may be a single wire formed using one conductor, or may be a strand wire formed by twisting a plurality of conductors.

The conductor 10 is, for example, a copper wire, an aluminium wire, or an alloy wire of these. A material of the copper wire is, for example, a tough pitch copper, an oxygen free copper, or a deoxidized copper. In addition, the copper wire is a plated copper wire of which the surface is plated with an annealed copper wire, a hard-drawn copper wire, tin, nickel, silver, or aluminium for example. The aluminium wire is, for example, a hard-drawn aluminium wire or a semihard-drawn aluminium wire. A material of the alloy wire is, for example, a copper-tin alloy, a copper-silver alloy, a copper-zinc alloy, a copper-chromium alloy, a copper-zirconium alloy, an aluminium-copper alloy, an aluminium-silver alloy, an aluminium-zinc alloy, an aluminium-iron alloy, or an aldrey aluminium alloy.

The thickness of the first insulating layer 11 made of the PPS or the PEEK formed in the outer surface of the conductor 10 is preferably 50 μm or more and 250 μm or less for example, and more preferably 80 μm or more and 200 μm or less for example. When the thickness of the first insulating layer 11 is 50 μm or more, for example, a withstanding performance sufficient for more securely preventing a breakdown of the insulation wire 1 (that is, a heat resistance and a voltage resistance) can be secured in a state where the insulation wires 1 are tightly disposed with a high density at the time of winding the insulation wire 1. However, when the thickness of the first insulating layer 11 exceeds 250 μm, cracks are easily generated at the time of winding the insulation wire 1. Further, the first insulating layer 11 may contain various types of additives to improve adhesion and moldability besides the PPS or the PEEK.

The second insulating layer 12 made of the uncured thermosetting resin preferably has an elongation percentage of 150% or more and 200% or less at a room temperature. The elongation percentage of the second insulating layer 12 may be calculated on the basis of a method of calculating an elongation defined in, for example, JIS C 3005:2014. Further, the insulation wire 1 is required to have a performance that no cracks and no peeling occur even when the insulation wire is bent at the same curvature as the diameter thereof after being extended by 30%. Therefore, it is more preferable that the elongation percentage of the second insulating layer 12 be equal to or more than 160%.

In addition, it is preferable for the second insulating layer 12 that a storage elastic modulus after curing be 10⁷ Pa or more at 200° C. The storage elastic modulus may be measured by a commercial viscoelasticity analyzer for example. Herein, the expression “after curing” means a state where a cross-linking (curing) reaction is made by heating.

The thermosetting resin forming the second insulating layer 12 may contain, for example, a phenoxy resin, an epoxy resin, a polyamide resin, and an epoxy curing agent. More specifically, the thermosetting resin forming the second insulating layer 12 may contain the phenoxy resin of 50 wt % or more and 80 wt % or less, the epoxy resin of 5 wt % or more and 15 wt % or less, the polyamide of 12 wt % or more and 36 wt % or less, and the epoxy curing agent of 5 wt % or more and 15 wt % or less.

In this way, the thermosetting resin forming the second insulating layer 12 may contain a thermoplastic polyamid resin which individually has a large elongation percentage and is excellent in heat resistance between the phenoxy resin and an epoxy resin cured product of the thermosetting resin component. The phenoxy resin is a thermoplastic resin which has a large elongation percentage of about 60% and is excellent in toughness and flexibility. Therefore, the polyamide resin is added in a sea-component of the phenoxy resin and the epoxy cured product as an island-component to form a sea-island structure, so that the elongation percentage of the second insulating layer 12 can be improved. In other words, the thermosetting resin forming the second insulating layer 12 has a structure in which the polyamide resin is dispersed in a mixture of the phenoxy resin and the epoxy resin.

The polyamide resin is used to improve the elongation percentage of the thermosetting resin forming the second insulating layer 12. The elongation percentage of the ployamide single body is, for example, about 400% to 600%. When a ratio of the polyamide resin to be mixed in the thermosetting resin is increased, the elongation percentage of the thermosetting resin is increased. However, since the polyamide resin is a thermoplastic resin, cross-linking density and the storage elastic modulus are lowered. Therefore, a mixture amount of the polyamide resin is preferably 12 wt % or more and 36 wt % or less. If the thermosetting resin forming the second insulating layer 12 contains the polyamide resin of 12 wt % or more, the elongation percentage can be increased to 150% or more, and if the mixture amount of the polyamide resin is 36 wt % or less, the storage elastic modulus can be increased to 10⁷ Pa or more at 200° C.

The epoxy curing agent is, for example, an aromatic epoxy resin, an alicyclic epoxy resin, a novolac epoxy resin, an aliphatic epoxy resin, glycidyl ester epoxy resin, a glycidyl amine type epoxy resin, a glycidyl acrylic type epoxy resin, a bisphenol A-type epoxy resin, a bisphenol F-type epoxy resin, or a polyester-type epoxy resin. A multifunctional epoxy resin is preferable in order to increase the cross-linking density. Further, a phenol resin and an acid anhydride may be used as the curing agent. Examples of the phenol resin include a phenol aralkyl resin (having a phenol skeleton or a dephenylene skeleton), a naphthol aralkyl resin, and a polyoxystyrene resin. In addition, as the phenol resin, a resol type phenol resin such as an aniline modified resol resin and a demethyl ether resol resin, a novolac type phenol resin such as a phenol novlac resin, a cresol novolac resin, a tert-butyl phenol novolac resin, and a nonyl phenol novolac resin, and a specific phenol resin such as a dicyclopentadiene modified phenol resin, a terpene modified phenol resin, and a triphenolmethane type resin. As a polyoxystyrene resin, a poly (p-oxystyrene) resin may be used. Among them, it is preferable that mp of a phenol novolac based resin be H-4 at 100° C. or less. As the acid anhydride, a tetrahydro phthalic anhydride and a hexahydro phthalic anhydride may be used for example. In addition, the curing accelerator of the epoxy resin includes a high temperature type of imidazoles which does not progress in the cross-linking reaction at the time of extrusion molding.

In addition, a combination of one or more types of a well-known coupling agent such as epoxy silane, aminosilane, ureidosilane, vinylsilane, arklsilane, and organic titanate, aluminium alkylate may be mixed in the thermosetting resin forming the second insulating layer 12 as needed. In addition, a combination of one or more types of phosphorus-nitrogen-containing compound such as red phosphorus, phosphoric acid, phosphoric acid ester, melamine, a melamine derivative, and a triazine ring, a cyanuric acid derivative, a nitrogen-containing compound of an isocyanuric acid derivative, and cyclophosphazene, a metallic compound such as a zinc oxide, an iron oxide, a molybdenum oxide, and ferrocene, an antimony oxide such as an antimony trioxide, an antimony tetroxide, and an antimony pentoxide, and a flame retardant such as a brominated epoxy resin may be mixed in the thermosetting resin.

A thickness of the second insulating layer 12 is preferably, for example, 20 μm or more and 80 μm or less. When the thickness of the second insulating layer 12 is 20 μm or more, an even thickness is easily secured when the second insulating layer 12 is molded by extrusion molding. In addition, when the thickness of the second insulating layer 12 is 80 μm or less, a space factor of the coil can be improved in a case where the insulation wire 1 is used as a winding coil.

In addition, in the insulation wire 1 of this embodiment, an adhesive force between the first insulating layer 11 and the second insulating layer 12 after curing does not relate to a temperature and is preferably 200 N or more and 800 N or less. The adhesive force between the first insulating layer 11 and the second insulating layer 12 after curing may be measured by a tensile test of a test piece created with reference to a fixing strength (stracker method) at a room temperature defined in an appendix JC of JIS C 2103:2013 as described below.

When the adhesive force between the first insulating layer 11 and the second insulating layer 12 after curing is 200 N or more, it is possible to more securely prevent the peeling of the second insulating layer 12 from the first insulating layer 11 caused by vibration of a motor for example. Further, in a range that the adhesive force between the first insulating layer 11 and the second insulating layer 12 after curing exceeds 800 N, the first insulating layer 11 is peeled from the conductor 10 when a load on the test piece exceeds 800 N, and thus the adhesive force cannot be measured.

### [Manufacturing Method of Insulation Wire]

Next, a manufacturing method of the insulation wire 1 according to this embodiment of the invention will be described. FIG. 2 is a flowchart illustrating a manufacturing method of the insulation wire 1 of this embodiment.

The manufacturing method of the insulation wire 1 of this embodiment is a manufacturing method of the insulation wire 1 which includes, as described above, the conductor 10, the first insulating layer 11 which is formed in the outer surface of the conductor 10, and the second insulating layer 12 which is formed in the outer surface of the first insulating layer 11. The manufacturing method of the insulation wire 1 of this embodiment mainly includes a first molding process S1 and a second molding process S2. In addition, the manufacturing method of the insulation wire 1 of this embodiment may include a plasma treatment process SP after the first molding process S1 and before the second molding process S2.

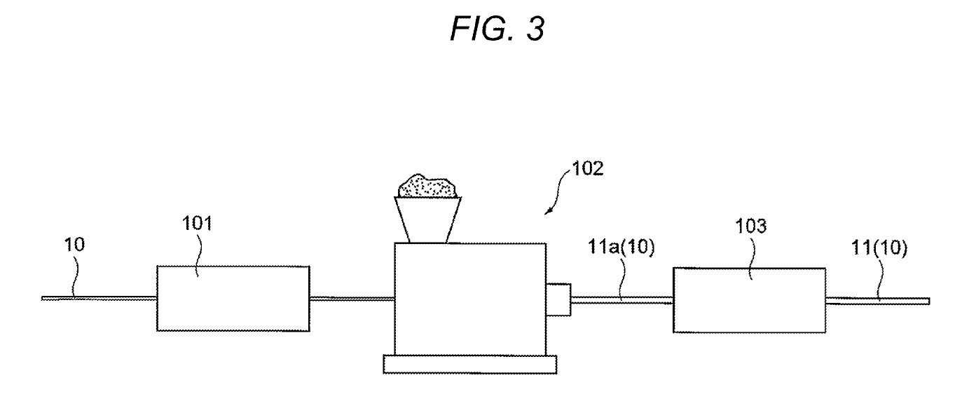

FIG. 3 is a schematic view for describing the first molding process S1. In the first molding process S1, the first insulating layer 11 which is the thermoplastic resin layer, is formed by molding the PPS or the PEEK in the outer surface of the conductor 10 by extrusion. More specifically, first, the conductor 10 is washed sufficiently with acetone, and passes through a heating furnace 101 while being sent by a drawing machine (not illustrated), and is preheated at a temperature of about 300° C. for example. Then the preheated conductor 10 is introduced to an extruding machine 102.

While passing through a crosshead and a die of the extruding machine 102, the conductor 10 introduced to the extruding machine 102 is subjected to a wire drawing process in which the wire is drawn until the wire diameter is reduced to a predetermined wire diameter. Further, the outer surface of the conductor 10 is subjected to a surface treatment by an organic metallic compound, for example, a silane coupling agent and the like, in order to improve adhesiveness between the outer surface of the conductor 10 and the first insulating layer 11.

In addition, the PPS or the PEEK of a pellet shape is inserted to a hopper of the extruding machine 102. In place of the PPS or the PEEK of the pellet shape, or together with the PPS or the PEEK of the pellet shape, a resin composition prepared with the PPS or the PEEK as a main body may be inserted to the hopper of the extruding machine. In addition, various types of resin materials and inorganic fillers to be contained in the first insulating layer 11 may be inserted to the hopper of the extruding machine 102. The resin material mixed to the resin composition is not particularly limited as long as the resin material does not damage the heat resistance of the first insulating layer 11, an insulating property, and the adhesiveness to the conductor 10, and has a melting point equal to or more than that of the thermoplastic resin of the second insulating layer 12.

The thermoplastic resin and other materials inserted to the hopper of the extruding machine 102 are supplied to a cylinder, kneaded together with the thermoplastic resin which is heated to be softened or melted in the cylinder, and then supplied to the crosshead die. The material of the first insulating layer 11 supplied to the crosshead die coats the outer surface of the conductor 10, and is extruded together with the conductor 10 from the extruding machine 102. Therefore, a layer 11a of the material of the first insulating layer 11 which is heated and kneaded in the cylinder of the extruding machine 102 is formed in the outer surface of the conductor 10 which has been passed through the extruding machine 102. At this time, a molding temperature is, for example, 280° C. or more and 360° C. or less.

The conductor 10 and the layer 11a of the material of the first insulating layer 11 of the outer surface, which passed through the extruding machine 102, pass through an electric furnace 103 which is adjusted in temperature at, for example, about 140° C., for crystallization, and to be cooled in a water bath of a cooling apparatus (not illustrated). As the result, the first insulating layer 11 is formed in the outer surface of the conductor 10. Since the first insulating layer 11 is made of the PPS, the PEEK, or the resin composition thereof, the first insulating layer can be molded thick in the outer surface of the conductor 10 by extrusion, and is excellent in insulating property and heat resistance compared to the insulating layer of a typical enamel wire. Further, the conductor 10 may pass through the extruding machine 102 plural times in order to form the first insulating layer 11 with a plurality of insulating layers.

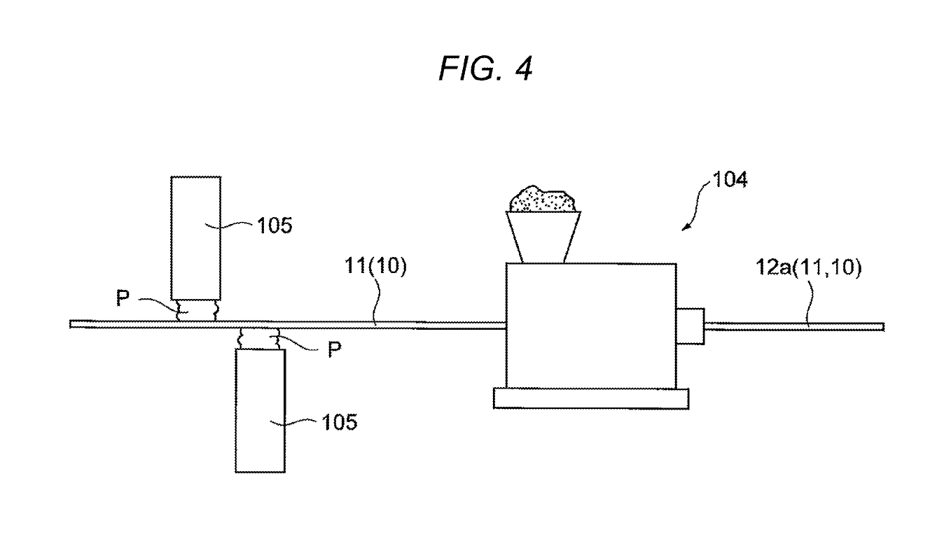

FIG. 4 is a schematic view for describing the second molding process S2 and the plasma treatment process SP. In the second molding process S2, the second insulating layer 12 is formed by molding the uncured thermosetting resin in the outer surface of the first insulating layer 11 by extrusion. More specifically, first, the conductor 10 in which the first insulating layer 11 is formed in the outer surface is heated to about 140° C. for example by the heating furnace (not illustrated) while being sent by the drawing machine, and is introduced to an extruding machine 104.

In addition, similarly to the first molding process S1, the material of the second insulating layer 12 of the pellet shape is inserted to the hopper of the extruding machine 104. In addition, various types of resin materials and inorganic fillers contained in the second insulating layer 12 may be inserted to the hopper of the extruding machine 104. The thermosetting resin and other materials inserted to the hopper of the extruding machine 104 are heated, kneaded, and supplied to the crosshead die similarly to the first molding process S1. In the second molding process S2, the temperature of the thermosetting resin at the time of extrusion molding may be, for example, 100° C. or more and 145° C. or less.

The material of the second insulating layer 12 supplied to the crosshead die of the extruding machine 104 coats the first insulating layer 11 formed in the outer surface of the conductor 10, and is extruded together with the conductor 10 from the extruding machine 104. Accordingly, a layer 12a of the material of the second insulating layer 12 is formed in the outer surface of the first insulating layer 11 of the conductor 10 passed through the extruding machine 104.

The layer 12a of the material of the second insulating layer 12 of the outer surface of the first insulating layer 11 of the conductor 10 passed through the extruding machine 104 is, for example, cooled in the water bath of the cooling apparatus (not illustrated). Accordingly, the insulation wire 1 is produced which includes the conductor 10, the first insulating layer 11 formed in the outer surface of the conductor 10, and the second insulating layer 12 formed in the outer surface of the first insulating layer 11.

Herein, the manufacturing method of the insulation wire 1 of this embodiment includes the plasma treatment process SP after the first molding process S1 and before the second molding process S2. In the plasma treatment process SP, the outer surface of the first insulating layer 11 formed in the outer surface of the conductor 10 is subjected to the plasma treatment.

More specifically, nozzles 105 of an atmospheric pressure plasma apparatus are provided to interpose the first insulating layer 11 formed in the outer surface of the conductor 10 by the first molding process S1. As the atmospheric pressure plasma apparatus, for example, the FG5001 plasma generator made by Plasmatreat may be used. Nitrogen, air, and oxygen may be used as gas.

The plasma P is irradiated from the nozzle 105 to modify the surface of the first insulating layer 11. In this embodiment, there are exemplified two nozzles 105 which are provided to interpose the conductor 10 formed with the first insulating layer 11 in the outer surface. The arrangement of the nozzles 105 is not particularly limited. For example, a plurality of the nozzles 105 may be provided along the conductor 10. In addition, the cross section of the nozzle 105 may be a circular shape or a rectangular shape.

In this way, since the outer surface of the first insulating layer 11 is subjected to the plasma treatment to be a plasma treatment surface in the plasma treatment process SP after the first molding process S1 and before the second molding process S2, the second insulating layer 12 can be formed in the plasma treatment surface of the first insulating layer 11 in the second molding process S2.

Therefore, the adhesiveness between the first insulating layer 11 and the second insulating layer 12 can be improved, and the adhesive force between the first insulating layer 11 and the second insulating layer 12 after curing can be made to be 200 N or more. Further, in a case where the storage elastic modulus of the second insulating layer 12 after curing is 10⁷ Pa or more at 200° C., the adhesive force between the first insulating layer 11 and the second insulating layer 12 after curing can be made to be 300 N or more at 200° C. by the plasma treatment of the outer surface of the first insulating layer 11.

The PPS or the PEEK of the first insulating layer 11 does not have a functional group in the resin surface, and thus there is a problem in the adhesiveness to the second insulating layer 12. However, the adhesiveness between the first insulating layer 11 and the second insulating layer 12 can be improved by the plasma treatment of the outer surface of the first insulating layer 11. In other words, the atmospheric pressure plasma is performed at a relative low temperature, has no discharge damage, and continuously occurs under a normal atmospheric pressure. Therefore, the adhesiveness between the first insulating layer 11 and the second insulating layer 12 can be improved by cleaning of the outer surface of the first insulating layer 11, dissolving of the resin of the outer surface, providing a hydroxyl group and an amino group, and an influence of a radical. In addition, the plasma treatment can be significantly reduced in risk of contamination of the outer surface after the treatment or a damage at the time of processing compared to a case where the outer surface of the first insulating layer 11 is oxidized by ozone or a strong acid, or subjected to a chemical coupling treatment.

As described above, the insulation wire 1 of this embodiment can be formed by molding the first insulating layer 11 and the second insulating layer 12 by extrusion with a sufficient thickness. Therefore, it is possible to provide the insulation wire 1 and the manufacturing method thereof which can securely prevent the breakdown compared to the related art while suppressing a reduction in productivity and an increase in manufacturing costs.

### [Manufacturing Method of Electric Machine]

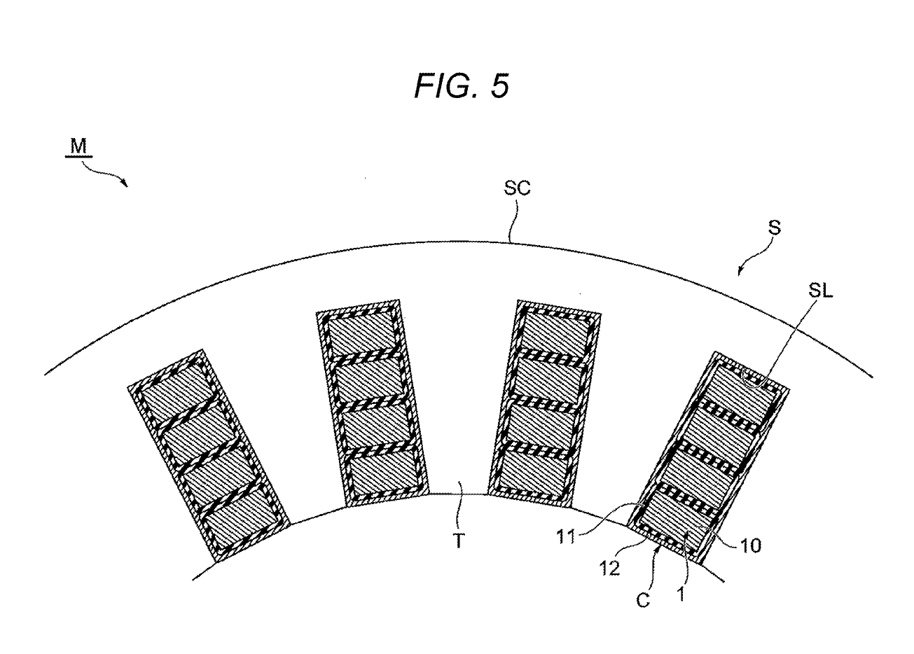

Next, a manufacturing method of the electric machine according to the embodiment of the invention will be described. FIG. 5 is a plan view schematically illustrating part of a stator S of a motor M which is an electric machine of this embodiment. The configuration other than the stator S of the motor M will be omitted in the drawing. The stator S includes a stator core SC and a coil C. The stator core SC includes a plurality of teeth T extending from the outside in a radial direction to the inside, and a slot SL which is formed between the teeth T. The coil C is formed by winding the insulation wire 1, and disposed in the slot SL of the stator core SC.

Hereinafter, the manufacturing method of the electric machine of this embodiment will be described.

The manufacturing method of the electric machine of this embodiment is a manufacturing method of the motor M equipped with the coil C obtained by winding the insulation wire 1. A manufacturing method of the motor M of this embodiment includes a winding process in which the insulation wire 1 is wound, and a thermosetting process in which the wound insulation wire 1 is heated to integrate the thermosetting resin of the second insulating layer 12 by being curing and self-fused. The processes of the motor M of this embodiment other than the process of fixing the coil C to the stator S may be performed by the conventional method, and thus the description thereof will be omitted.

In the winding process, the insulation wire 1 is wound and disposed in the slot SL of the stator core SC. Herein, in the insulation wire 1, the first insulating layer 11 formed in the outer surface of the conductor 10 is the thermoplastic resin layer made of the PPS or the PEEK, and the second insulating layer 12 formed in the outer surface of the first insulating layer 11 is the thermosetting resin layer made of the uncured thermosetting resin. Therefore, it is prevented that the second insulating layer 12 is cracked at the time of winding the insulation wire 1. The effect of preventing the damage on the second insulating layer 12 at the time of winding the insulation wire 1 is remarkably exhibited in a case where the elongation percentage of the second insulating layer 12 is 150% or more and 200% or less at the room temperature.

In the thermosetting process, the wound insulation wire 1 is heated to cure the thermosetting resin of the second insulating layer 12 so as to be integrally self-fused. The uncured thermosetting resin of the second insulating layer 12 of the insulation wire 1 flows by the heating, and is self-fused, and then heat-crosslinked. Therefore, there is no need to use an impregnation varnish to bond the coil C, the manufacturing procedure can be simplified to improve the productivity, and the manufacturing costs can be reduced. Further, the temperature to heat the insulation wire 1 in the thermosetting process is, for example, 150° C. or more and 200° C. or less. The heating time is, for example, 1 hour or more and 3 hours or less, and it is preferable to reduce the time as short as possible.

For example, in a case where the PPS or the PEEK is used as the insulating layer of the outermost layer of the insulation wire, the adhesiveness at a high temperature of about 200° C. is insufficient even the bonding process is performed using a varnish. Therefore, there is a problem in adhesiveness between the varnish and the insulation wire. On the contrary, in the insulation wire 1 of this embodiment, the insulation wire 1 is self-fused by the second insulating layer 12 which is formed in the outer surface of the first insulating layer 11 made of the PPS or the PEEK, so that the problem in adhesiveness of the insulation wire 1 can be solved.

In addition, in a case where the second insulating layer 12 of the insulation wire 1 has a storage elastic modulus of 10⁷ Pa or more at 200° C. after curing, the adhesiveness to the first insulating layer 11 is improved, the heat resistance of the motor M and the durability such as resistance against vibrations can be improved. In particular, the heat resistance of the motor M and the durability such as the resistance against vibrations can be improved still more, and a reliability at a high temperature can be improved by performing the plasma process on the outer surface of the first insulating layer 11 of the insulation wire 1 to set the adhesive force with respect to the first insulating layer 11 and the second insulating layer 12 to 200 N or more.

As above, a manufacturing method of the motor M which is the electric machine of this embodiment has been described. The insulation wire 1 used in the manufacturing method of this embodiment does not cause the cracks and the peeling in the first insulating layer 11 and the second insulating layer 12 at the time of winding, and self-fused and crosslinked when being heated. Therefore, the insulation wire 1 is suitable to the coil C of a rotary electric machine such as the motor M. In addition, the second insulating layer 12 of the insulation wire 1 has an excellent adhesiveness to the PPS or the PEEK of the first insulating layer 11 before the thermosetting resin is cured, and has a high elongation percentage.

The electric machine such as the motor M manufactured by the manufacturing method of the electric machine of this embodiment is provided with the insulation wire 1 which is excellent in the heat resistance and the withstanding performance. Therefore, the electric machine is suitable as a drive power generation apparatus or an electric power generation apparatus in a household or industry electric machine, or ships, railway vehicles, or an electric vehicle for example. In particular, the electric machine hardly causes the breakdown due to heat, partial discharge, or a surge voltage even in a compact or high-output rotary electric machine.

Hitherto, the embodiments of the invention have been described using the drawings. However, the specific configurations are not limited to the embodiments, and variations in design within a scope not departing from the spirit of the invention shall be included in the invention.

Next, examples of the invention will be described.

### First Example

A rectangular copper wire (2.0 mm×3.2 mm in cross-sectional dimension) was prepared as a conductor, sufficiently cleaned using acetone, and preheated at 300° C. Then, a material of the first insulating layer was melted and kneaded, passed through the crosshead die at 300° C. to be molded by extrusion, and adjusted in temperature at 140° C. to be crystallized. Accordingly, the first insulating layer of a thickness of 150 μm was formed in the outer surface of the conductor. As a material of the first insulating layer, the PPS (Torelina T1881 made by Toray) was used.

Next, the atmospheric pressure plasma process was performed on the outer surface of the first insulating layer formed in the outer surface of the conductor similarly to the manufacturing method of the insulation wire described in the above embodiments, and the entire surface of the outer surface of the first insulating layer became the plasma treatment surface to which the atmospheric plasma treatment (nitrogen gas) was performed.

Next, the outer surface of the first insulating layer formed in the outer surface of the conductor was preheated at a temperature of 140° C., a material of the second insulating layer was melted and kneaded at a temperature of 125° C., and then molded by extrusion at a temperature of 140° C. Accordingly, the second insulating layer of 50 μm was formed in the outer surface of the first insulating layer to obtain the insulation wire of the first example.

More specifically, the material of the second insulating layer was inserted in a polyethylene bag and roughly blended, then kneaded at 125° C. and at a rotation frequency of 20 rpm in a biaxial kneading machine to obtain the thermosetting resin of the pellet shape. Then, the thermosetting resin of the pellet shape was inserted to the hopper of the extruding machine while heating the first insulating layer formed in the outer surface of the conductor at 140° C. in the heating furnace, and molded by extrusion at a temperature of 140° C. and cooled, so that the second insulating layer of 50 μm was formed in the outer surface of the first insulating layer. Further, the thickness of the second insulating layer varied according to an extrusion speed and viscosity of the material of the second insulating layer, and a sending speed of the conductor.

As the material of the second insulating layer, 69 wt % of the phenoxy resin (YP-70 made by Nippon Steel & Sumikin Chemical Co., Ltd.), 10.3 wt % of the epoxy resin (TECHMORE VG3101 made by Printec, Inc.), 6.9 wt % of the epoxy resin curing agent (HN-2200 made by Hitachi Chemical Company, Ltd.), 0.9 wt % of the imidazole (2PHZ-PW made by Shikoku Chemicals Corporation) which was the curing accelerator of the epoxy resin, and 12.9 wt % of the polyamide resin (UBESTA XPA 9035F made by Ube Industries) were used at this ratio.

Next, the elongation percentage of the uncured second insulating layer, the storage elastic modulus of the second insulating layer after curing, a tensile strength (adhesive force) of a test piece of the insulation wire in which the second insulating layer was self-fused and cured, and a bending workability of the insulation wire having the uncured insulating layer were measured and verified.

The elongation percentage of the uncured second insulating layer was obtained as follows. First, the uncured thermosetting resin obtained from the nozzle of the biaxial kneading machine was pulled out at a speed of 6 m/minute to produce a fiber having a diameter of 100 μm or more and 300 μm or less. The fiber was pulled out at a speed of 50 mm/minute in a marked line distance of 127 mm using a tensile tester (Shimadzu Corporation, autograph AGS-100G, Load cell SBE1kN). Then, the elongation percentage was obtained by the following Equation (1) on the basis of an elongation calculating method defined in JIS C 3005:2014.

(Expression 1)

ε={(l₁−l₀)/l₀}×100 (1)

In the above Equation (1), ε is the elongation percentage (%), l₁ is a distance between marks at the time of cutting, and l₀ is a marked line distance.

The storage elastic modulus of the second insulating layer after curing was measured as follows. First, the uncured thermosetting resin of the pellet shape obtained by kneading by the biaxial kneading machine was applied with a pressure of 1 MPa by a vacuum compressor to be heated and cured at 180° C. for one hour so as to obtain the thermosetting resin having a thickness of 1.0 mm after curing. The thermosetting resin after curing was made as a test piece of 0.5 mm thick, 4 mm wide, and 3 cm long. The storage elastic modulus (E′) of the test piece was obtained in a tensile mode at a temperature rising rate of 5° C./minute using a dynamic viscoelasticity measuring apparatus (itk DVA-225 made by IT Measurement Control Corporation). The measurement temperature was set in a range from the room temperature to 300° C.

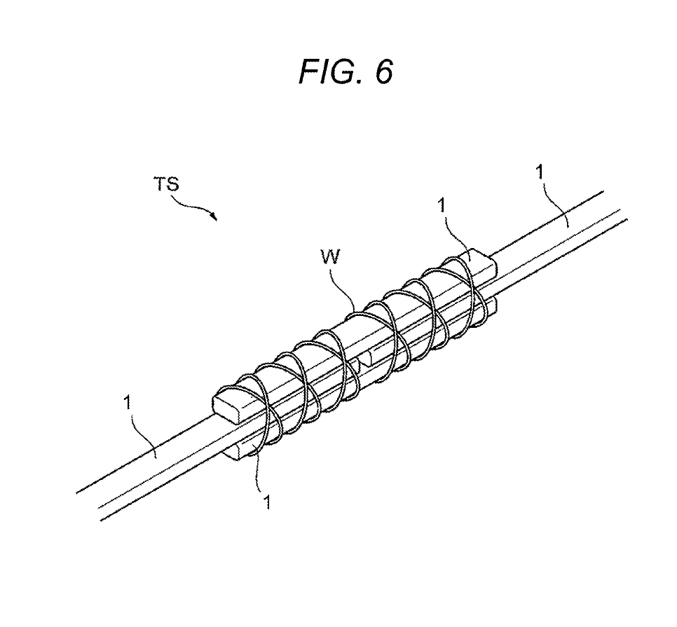

FIG. 6 is a perspective view of a test piece TS used to measure the tensile strength (adhesive force) of the insulation wire 1 in this example. The tensile strength (adhesive force) of the insulation wire 1 in this example was measured as the following procedure. First, the insulation wire 1 was extended by 30% in simulation of a winding process of the coil, and then cut by a length of 10 cm. The cut wires were fixed by a wire W as illustrated in FIG. 6, and heated for one hour at 180° C. while applying a load of 5 kg so as to fix the insulation wires 1 by the self-fusion, and the second insulating layer was cured to obtain the test piece TS.

Even though the test piece was heated from the room temperature to 250° C. at a temperature rising rate of 5° C./minute by a differential scanning calorimeter, the heating caused by the cross-linking of the thermosetting resin was not observed. Therefore, in the test piece TS, it was confirmed that the insulation wire 1 was completely cross-linked by heating for one hour at a temperature of 180° C. Thereafter, both ends of the test piece TS were interposed using a clamp with a gap of 12 cm, a tensile test was performed at a tensile speed of 5 mm/minute using a universal tensile tester, and a tensile strength (adhesive force) to break the self-fusion surface was evaluated. The tensile test was performed at the room temperature and at 200° C.

In addition, the bending workability of the insulation wire having the uncured second insulating layer was evaluated by an edge wire test as follows. First, a sample obtained by elongating 30% of the insulation wire having the uncured second insulating layer was prepared, and a hand bender (Duo-Mite made by Oxford General Industries) was used as a bending machine to bend the sample by 180° with R=3.2 mm. At this time, the bending was performed so as to make the long side of the cross section of the 3.2 mm×2.0 mm insulation wire be the bending radius. Thereafter, fractures, cracks, and peeling of the resin layer of the bending portion of the insulation wire were observed by a microscope.

In Table 1 below, a weight ratio of the composition of the second insulating layer of the insulation wire of the first example, presence/absence of the atmospheric pressure plasma process on the outer surface of the first insulating layer, the elongation percentage of the uncured second insulating layer, the storage elastic modulus of the second insulating layer after curing, the tensile strength (adhesive force), and the bending workability of the insulation wire having the uncured second insulating layer are listed. Further, the bending workability of the insulation wire indicates presence/absence of fractures, cracks, and peeling of the resin layer of the bending portion of the insulation wire.

TABLE 1

| | | Example | | | | | | | |
|---|---|---|---|---|---|---|---|---|---|
| | | 1 | 2 | 3 | 4 | 5 | 6 | 7 | 8 |
| Material of | Phenoxy resin | 69.0 | 67.3 | 72.1 | 54.1 | 62.5 | 79.2 | 61.4 | 69.0 |
| second resin | Epoxy resin | 0.0 | 0.0 | 0.0 | 0.0 | 0.0 | 0.0 | 13.2 | 0.0 |
| layer | Epoxy resin | 0.0 | 0.0 | 0.0 | 18.0 | 0.0 | 9.9 | 0.0 | 0.0 |
| [wt %] | Epoxy resin | 10.3 | 0.0 | 0.0 | 0.0 | 0.0 | 0.0 | 0.0 | 10.3 |
| | Epoxy resin | 0.0 | 9.6 | 7.2 | 0.0 | 15.6 | 0.0 | 0.0 | 0.0 |
| | Epoxy curing agent | 0.0 | 0.0 | 0.0 | 13.5 | 0.0 | 0.0 | 0.0 | 0.0 |
| | Epoxy curing agent | 6.9 | 0.0 | 9.0 | 0.0 | 11.7 | 0.0 | 0.0 | 6.9 |
| | Epoxy curing agent | 0.0 | 9.6 | 0.0 | 0.0 | 0.0 | 9.9 | 13.2 | 0.0 |
| | Imidazole | 0.9 | 1.0 | 0.9 | 0.9 | 0.0 | 1.0 | 0.9 | 0.9 |
| | Polyamide resin | 12.9 | 12.5 | 10.8 | 13.5 | 10.2 | 0.0 | 11.4 | 12.9 |

| | | | | | | | | |
|---|---|---|---|---|---|---|---|---|
| Atmospheric pressure plasma treatment | Presence | Presence | Presence | Presence | Presence | Presence | Presence | Absence |
| Elongation percentage [%] in uncured | 155 | 160 | 175 | 165 | 185 | 60 | 160 | 155 |
| second resin layer | | | | | | | | |
| Storage elastic modulus [Pa] @ 200 | 2.6 × 10⁷ | 1.3 × 10⁷ | 2.9 × 10⁷ | 3.6 × 10⁷ | 1.3 × 10⁸ | 3.9 × 10⁷ | — | 2.6 × 10⁷ |
| [° C.] of second resin layer after | | | | | | | | |
| curing | | | | | | | | |
| Tensile strength [N] @ room | 750 | 800 | 700 | 650 | 650 | 750 | 850 | 750 |
| temperature | | | | | | | | |
| Tensile strength [N] @ 200 [° C.] | 360 | 400 | 380 | 400 | 320 | 300 | 100 | 360 |
| Bending workability (fractures) | Absence | Absence | Absence | Absence | Absence | Presence | Absence | Presence |

As listed in Table 1, the insulation wire of the first example shows that the elongation percentage of the uncured second resin layer is 155%, the storage elastic modulus of the second resin layer after curing at 200° C. is 2.6×10⁷ Pa, the tensile strength (adhesive force) is 750 N at the room temperature and 360 N at 200° C., and the bending workability is good without fractures.

### Second Example

The insulation wire of a second example was produced similarly to the insulation wire of the first example except that the material of the second insulating layer was different from that of the insulation wire of the first example. Specifically, 9.6 wt % of EPICLON EXA-4700 made by DIC Corporation was used as the epoxy resin in place of TECHMORE VG3101 made by Printec, Inc., and 9.6 wt % of MEH-7800 made by Meiwa Plastic Industries, Ltd. was used in place of HN-2200 made by Hitachi Chemical Company, Ltd. as the epoxy curing agent. In addition, the phenoxy resin, the imidazole, and the polyamide resin of the same type of those of the insulation wire of the first example were used as the material of the second insulating layer at a weight ratio of 67.3 wt %, 1.0 wt %, and 12.5 wt % respectively.

As listed in Table 1, the insulation wire of the second example shows that the elongation percentage of the uncured second resin layer is 160%, the storage elastic modulus of the second resin layer after curing at 200° C. is 1.3×10⁷ Pa, the tensile strength (adhesive force) is 800 N at the room temperature and 400 N at 200° C., and the bending workability is good without fractures. Further, the first insulating layer was peeled from the conductor under a load larger than 800 N in the measurement of the tensile strength (adhesive force), and the tensile strength (adhesive force) was not able to be measured.

### Third Example

The insulation wire of a third example was produced similarly to the insulation wire of the first and second examples except that the material of the second insulating layer was different from that of the insulation wire of the first and second examples. Specifically, the phenoxy resin, the epoxy curing agent, the imidazole, and the polyamide resin of the same type of those of the insulation wire of the first example were used as the material of the second insulating layer at a weight ratio of 72.1 wt %, 9.0 wt %, 0.9 wt %, and 10.8 wt % respectively. In addition, 7.2 wt % of the epoxy resin of the same type as that of the insulation wire of the second example was used as the material of the second insulating layer.

As listed in Table 1, the insulation wire of the third example shows that the elongation percentage of the uncured second resin layer is 175%, the storage elastic modulus of the second resin layer after curing at 200° C. is 2.9×10⁷ Pa, the tensile strength (adhesive force) is 700 N at the room temperature and 380 N at 200° C., and the bending workability is good without fractures.

### Fourth Example

The insulation wire of a fourth example was produced similarly to the insulation wire of the first to third examples except that the material of the second insulating layer was different from that of the insulation wire of the first to third examples. Specifically, the phenoxy resin, the imidazole, and the polyamide resin of the same type of those of the insulation wire of the first example were used as the material of the second insulating layer at a weight ratio of 54.1 wt %, 0.9 wt %, and 13.5 wt % respectively. In addition, 18.0 wt % of the epoxy resin YL6121H made by Mitsubishi Chemical Corporation was used as the epoxy resin in place of TECHMORE VG3101 made by Printec, Inc. used in the insulation wire of the first example, and 13.5 wt % of the epoxy resin curing agent H-4 made by Meiwa Plastic Industries, Ltd. was used as the epoxy resin curing agent in place of HN-2200 made by Hitachi Chemical Company, Ltd.

As listed in Table 1, the insulation wire of the fourth example shows that the elongation percentage of the uncured second resin layer is 165%, the storage elastic modulus of the second resin layer after curing at 200° C. is 3.6×10⁷ Pa, the tensile strength (adhesive force) is 650 N at the room temperature and 400 N at 200° C., and the bending workability is good without fractures.

### Fifth Example

The insulation wire of a fifth example was produced similarly to the insulation wire of the first to fourth examples except that the material of the second insulating layer was different from that of the insulation wire of the first to fourth examples. Specifically, the phenoxy resin, the epoxy curing agent, and the polyamide resin of the same type of those of the insulation wire of the first example were used as the material of the second insulating layer at a weight ratio of 62.5 wt %, 11.7 wt %, and 10.2 wt % respectively. In addition, 15.6 wt % of the epoxy resin of the same type as that of the insulation wire of the second example was used as the material of the second insulating layer.

As listed in Table 1, the insulation wire of the fifth example shows that the elongation percentage of the uncured second resin layer is 185%, the storage elastic modulus of the second resin layer after curing at 200° C. is 1.3×10⁸ Pa, the tensile strength (adhesive force) is 650 N at the room temperature and 320 N at 200° C., and the bending workability is good without fractures.

### Sixth Example

The insulation wire of a sixth example was produced similarly to the insulation wire of the first to fifth examples except that the material of the second insulating layer was different from that of the insulation wire of the first to fifth examples. Specifically, the phenoxy resin and the imidazole of the same type of those of the insulation wire of the first example were used as the material of the second insulating layer at a weight ratio of 79.2 wt % and 1.0 wt % respectively. In addition, 9.9 wt % of the epoxy resin of the same type of that of insulation wire of the fourth example was used as the material of the second insulating layer, and 9.9 wt % of the epoxy resin curing agent of the same type of the insulation wire of the second example was used. Further, the polyamide resin was not used as the material of the second insulating layer.

As listed in Table 1, the insulation wire of the sixth example shows that the elongation percentage of the uncured second resin layer is 60%, the storage elastic modulus of the second resin layer after curing at 200° C. is 3.9×10⁷ Pa, the tensile strength (adhesive force) is 750 N at the room temperature and 300 N at 200° C., and the bending workability is good without fractures. However, the cracks not found in the evaluation of the bending workability in a case where the elongation percentage of the uncured second resin layer was 150% or more were found, and the bending workability was lowered compared to the first to fifth examples. Therefore, it can be seen that the elongation percentage of the uncured second resin layer is preferably 150% or more.

### Seventh Example

The insulation wire of a seventh example was produced similarly to the insulation wire of the first to sixth examples except that the material of the second insulating layer was different from that of the insulation wire of the first to sixth examples. Specifically, the phenoxy resin, the imidazole, and the polyamide resin of the same type of those of the insulation wire of the first example were used as the material of the second insulating layer at a weight ratio of 61.4 wt %, 0.9 wt %, and 11.4 wt % respectively. Further, 13.2 wt % of the epoxy curing agent of the same type of the insulation wire of the second example was used. In addition, 13.2 wt % of a bifunctional epoxy resin jER1011 made by Mitsubishi Chemical Corporation was used as the epoxy resin in place of TECHMORE VG3101 made by Printec, Inc. used in the insulation wire of the first example.

As listed in Table 1, the insulation wire of the seventh example shows that the elongation percentage of the uncured second resin layer is 160%, but the storage elastic modulus of the second resin layer after curing at 200° C. was not able to be measured because the cross-linking density of the resin is low and the resin is broken at the time of measuring. For this reason, the tensile strength (adhesive force) was 850 N at the room temperature, and lowered to 100 N at 200° C. Therefore, it can be seen that the epoxy resin is preferably trifunctional or more.

### Eighth Example

The insulation wire of an eighth example was produced similarly to the insulation wire of the first example except that the atmospheric plasma treatment was omitted. As listed in Table 1, the cracks was generated in the insulation wire of the eighth example in the evaluation of the bending workability, and the bending workability was lowered even though the elongation percentage of the uncured second resin layer, the storage elastic modulus of the second resin layer after curing at 200° C., and the tensile strength (adhesive force) were the same as those of the insulation wire of the first example. Therefore, it can be seen that the atmospheric plasma treatment on the outer surface of the first insulating layer of the insulation wire contributes to an improvement of the bending workability of the insulation wire.

What is claimed is:

1. An insulation wire, comprising:
a conductor;
a first insulating layer formed in an outer surface of the conductor; and
a second insulating layer formed in an outer surface of the first insulating layer,
wherein the first insulating layer is a thermoplastic resin layer that is made of polyphenylene sulfide or polyether ether ketone, and
wherein the second insulating layer is a thermosetting resin layer that is made of an uncured thermosetting resin.

2. The insulation wire according to claim 1,
wherein the second insulating layer is configured such that an elongation percentage of the uncured thermoplastic resin is 150% or more and 200% or less at a room temperature.

3. The insulation wire according to claim 1,
wherein the second insulating layer is configured such that a storage elastic modulus after curing is 10⁷ Pa or more at 200° C.

4. The insulation wire according to claim 1,
wherein the thermosetting resin includes a phenoxy resin, the epoxy resin, a polyamide resin, and an epoxy curing agent.

5. The insulation wire according to claim 4,
wherein the thermosetting resin contains a phenoxy resin of 50 wt % or more and 80 wt % or less, an epoxy resin of 5 wt % or more and 15 wt % or less, a polyamide resin of 12 wt % or more and 36 wt % or less, and an epoxy curing agent of 5 wt % or more and 15 wt % or less.

6. A manufacturing method of an insulation wire that includes a conductor, a first insulating layer formed in an outer surface of the conductor, and a second insulating layer formed in an outer surface of the first insulating layer, comprising:
a first molding process of forming the first insulating layer by molding polyphenylene sulfide or polyether ether ketone in the outer surface of the conductor by extrusion; and
a second molding process of forming the second insulating layer by molding an uncured thermosetting resin in the outer surface of the first insulating layer by extrusion.

7. A manufacturing method of the insulation wire according to claim 6, further comprising:
a plasma treatment process of performing a plasma treatment on the outer surface of the first insulating layer after the first molding process and before the second molding process.

8. The manufacturing method of the insulation wire according to claim 6,
wherein, in the second molding process, a temperature of the thermosetting resin at the time of extrusion molding is 100° C. or more and 145° C. or less.

9. A manufacturing method of an electric machine that includes a coil obtained by winding the insulation wire according to claim 1, comprising:
a winding process of winding the insulation wire; and
a thermosetting process of heating the wound insulation wire to cure the thermosetting resin of the second insulating layer so as to be integrally self-fused.

10. The manufacturing method of the electric machine according to claim 9,
wherein a temperature to heat the insulation wire in the thermosetting process is 150° C. or more and 200° C. or less.
